(19) United States
(12) Patent Application Publication
(10) Pub. No.: US 2013/0044561 A1
(43) Pub. Date: Feb. 21, 2013

(54) LIQUID MIXER AND FROTHER

(71) Applicants: David A. Holcomb, Seattle, WA (US); Adam A. Jossem, Seattle, WA (US)

(72) Inventors: David A. Holcomb, Seattle, WA (US); Adam A. Jossem, Seattle, WA (US)

(73) Assignee: CHEF'N CORPORATION, Seattle, WA (US)

(21) Appl. No.: 13/587,706

(22) Filed: Aug. 16, 2012

Related U.S. Application Data
(60) Provisional application No. 61/524,213, filed on Aug. 16, 2011.

(51) Int. Cl. B01F 7/16

(52) U.S. Cl. 366/244

(57) ABSTRACT

A device for mixing and frothing a liquid incorporates a container and a removable insert. The container has a bottom, a sidewall, and at least one opening. An upper portion of the insert projects outwards from the container. A lower portion of the insert has a shaft with a distal end located near the bottom of the container during operation. A motor is operable to rotate the shaft. A mixing blade is fixedly coupled with respect to the distal end of the shaft. A frothing assembly is movably coupled to the shaft, and incorporates a float and a frother. The float and frother remain near an upper surface of the liquid such that, regardless of the liquid level, the frother is position near the top surface to selectively froth the liquid therein.

### CROSS-REFERENCE TO RELATED APPLICATION

This application claims the benefit under 35 U.S.C. §119(e) of U.S. Provisional Patent Application No. 61/524,213 filed Aug. 16, 2011, which is incorporated herein by reference in its entirety.

### BACKGROUND OF THE INVENTION

1. Field of the Invention

The present disclosure generally is related to kitchen tools, and more particularly, to tools for mixing and frothing liquids.

2. Description of the Related Art

A wide variety of tools exist for mixing liquids and for frothing liquids, including but not limited to beverages such as chocolate milk or hot cocoa. A device that combines these functions has advantages.

### BRIEF SUMMARY OF THE INVENTION

In one embodiment, a device for simultaneously mixing and frothing a liquid incorporates a container and an insert. The container is adapated to hold a volume of the liquid. The container has a bottom, a sidewall, and at least one opening. The insert is removably received by the container during use. The insert has an upper portion and a lower portion. The upper portion of the insert projects outwards from the container during operation. The lower portion of the insert has a shaft with a distal end located near the bottom of the container during operation. A motor is operable to rotate the shaft during operation. A mixing blade is fixedly coupled with respect to the distal end of the shaft. A frothing assembly is movably coupled to the shaft. The frothing assembly incorporates a float and a frother. The float is adapted to maintain the float and the frother near an upper surface of the liquid during use such that, regardless of the liquid level in the container, the frother is position near the top surface to selectively froth the liquid therein.

### BRIEF DESCRIPTION OF THE SEVERAL VIEWS OF THE DRAWING(S)

FIG. 1 is a perspective view of a container and insert adapted to mix and froth a liquid, according to one embodiment.

FIG. 2 is an elevation view of the insert of FIG. 1 removed from the container.

FIG. 3 is an elevation view of the insert of FIG. 2 with a portion of a housing removed to show elements inside the housing.

FIG. 4 is a top perspective view of the insert of FIG. 3 with a portion of a cap removed to show elements inside the cap.

FIG. 5 is a top perspective view of the insert of FIG. 4 with additional portions of the cap removed.

FIGS. 6A-6C are cross-sectional views of the container and insert of FIG. 1, viewed along Section 6-6, collectively depicting the container containing three different levels of the liquid.

### DETAILED DESCRIPTION OF THE INVENTION

The following detailed description is directed toward devices for mixing and frothing liquids, such as hot cocoa and other beverages and liquids. The following detailed description and corresponding figures are intended to provide an individual of ordinary skill in the art with enough information to enable that individual to make and use embodiments of the invention. Such an individual, however, having read this entire detailed description and reviewed the figures, will appreciate that modifications can be made to the illustrated and described embodiments, and/or elements removed therefrom, without deviating from the spirit of the invention. It is intended that all such modifications and deviations fall within the scope of the invention, to the extent they are within the scope of the associated claims.

Reference throughout this specification to “one embodiment” or “an embodiment” means that a particular feature, structure or characteristic described in connection with the embodiment is included in at least one embodiment of the disclosed methods and structures. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

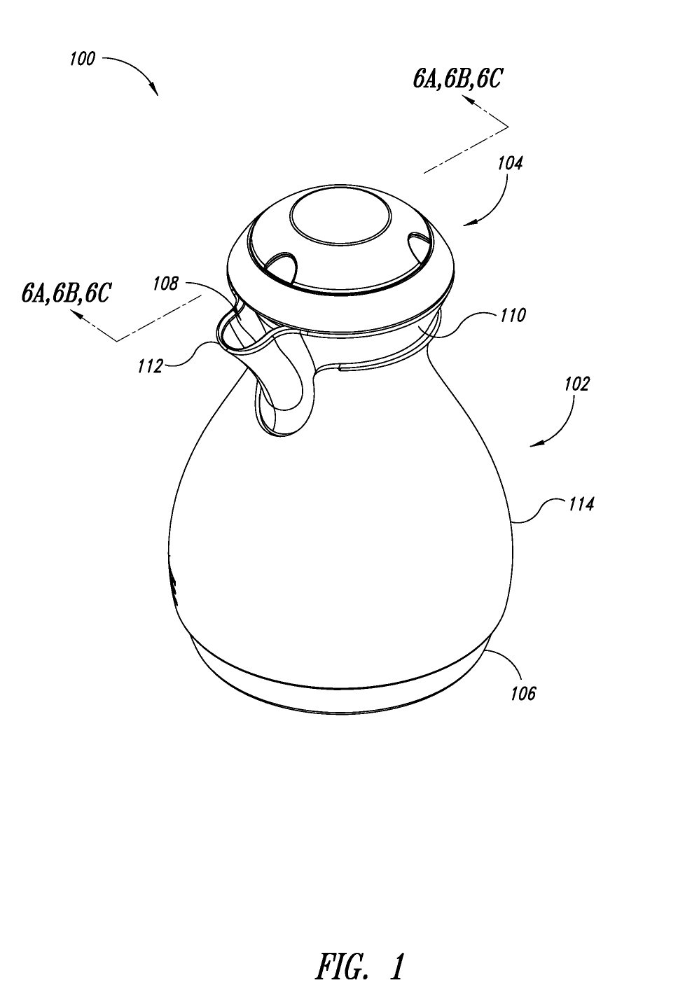

FIG. 1 illustrates a mixing and frothing device 100 according to one particular embodiment. The device 100 generally incorporates a container 102 and an insert 104. The illustrated container 102 is in the form of a pitcher 106 with an opening 108 at an upper end 110. The opening 108 in the illustrated pitcher 106 is formed with a spout 112. In this particular embodiment, the pitcher 106 is adapted for holding heated liquids; it is made using ceramic, although other materials could be used. The pitcher 106 also can be covered, at least partially, with a sleeve 114, which can facilitate manipulation of the device 100 when it contains heated liquid. The illustrated insert 104 mates with the opening 108 in the pitcher 106. An individual of ordinary skill in the art, having reviewed this entire disclosure, will immediately appreciate that various changes can be made to the container and pitcher without deviating from the spirit of the invention.

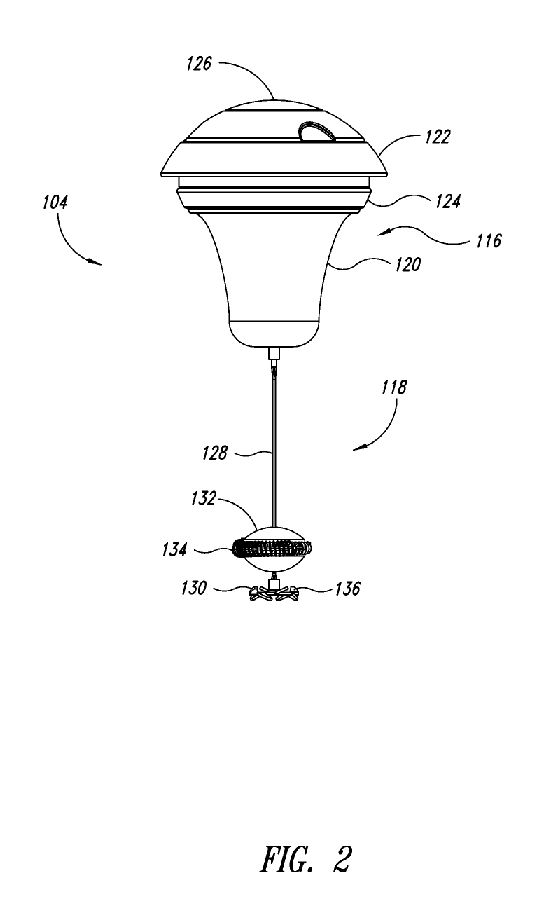

FIG. 2 illustrates the insert 104 removed from the container 102. The insert 104 has an operating end 116 and an opposing working end 118. The operating end 116 of the insert 104 engages and projects outward from the opening 108 in the container 102 such that the user can contact the insert to operate the device 100. The working end 118 of the insert projects into the container 102 to mix and froth a liquid therein during use.

The operating end 116 of the illustrated insert 104 incorporates a housing 120 and a cap 122. The housing 120 can be designed to prevent liquid in the container 102 from contacting components inside the operating end 116 of the insert 104. The cap 122 mates with the housing 120 and covers and can protect the housing's internal components from elements outside the device 100. A seal 124 between the housing 120 and the cap 122 can contact the opening 108 in the pitcher 106 and prevent liquid from escaping from the device during use. A button 126 or other actuator at the top of the cap 122 can be depressed or otherwise manipulated to operate the device 100. The illustrated button 126 is covered with a layer of flexible and resilient material to allow the user to actuate the button without allowing liquid or other elements to enter the working end 116 of the device 100.

The working end 118 of the illustrated insert 104 incorporates a shaft 128, a mixer 130, a float 132, and a frother 134. The shaft 128 projects from the housing 120, extending a distance selected to reach close to a bottom of the pitcher 106 or other container. As discussed below, the shaft 128 rotates with respect to the operating end 116 of the insert 104 to mix and froth a liquid in the container 120.

The mixer 130 is fixedly mounted to an end of the shaft 128 and rotates as a unit therewith to mix, stir or otherwise agitate the liquid in the container 102. The illustrated mixer 130 has several angled blades 136 spaced radially around a perimeter of the mixer, angled to cause the liquid to move vertically (when the illustrated device 100 is resting on a horizontal counter) when the shaft 128 and mixer 130 rotates in the liquid. The mixer 130 can be permanently affixed to the shaft 128 or removably coupled thereto to be removed for cleaning, replacement, or otherwise.

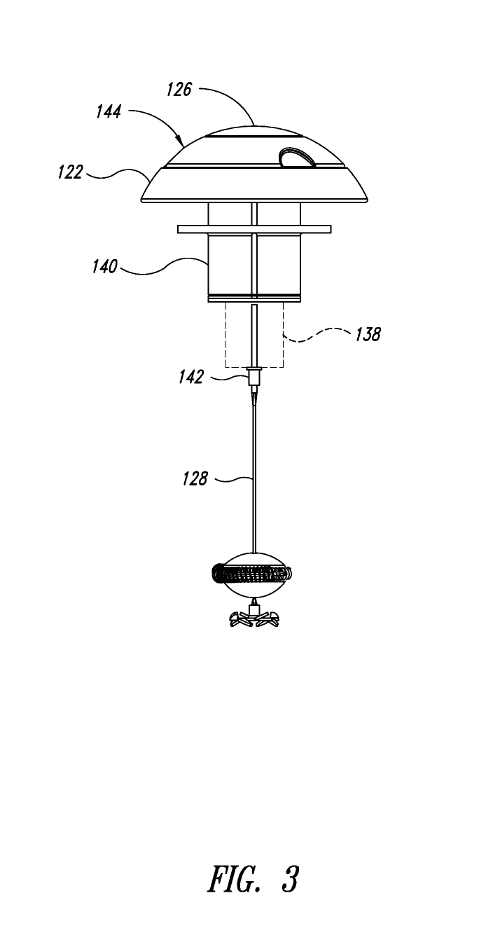

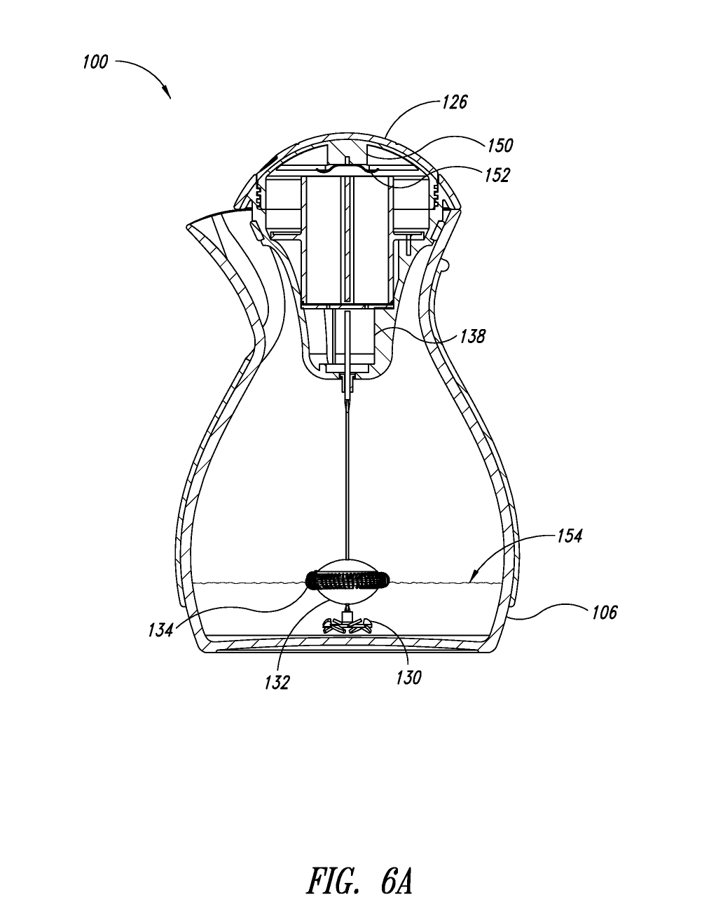

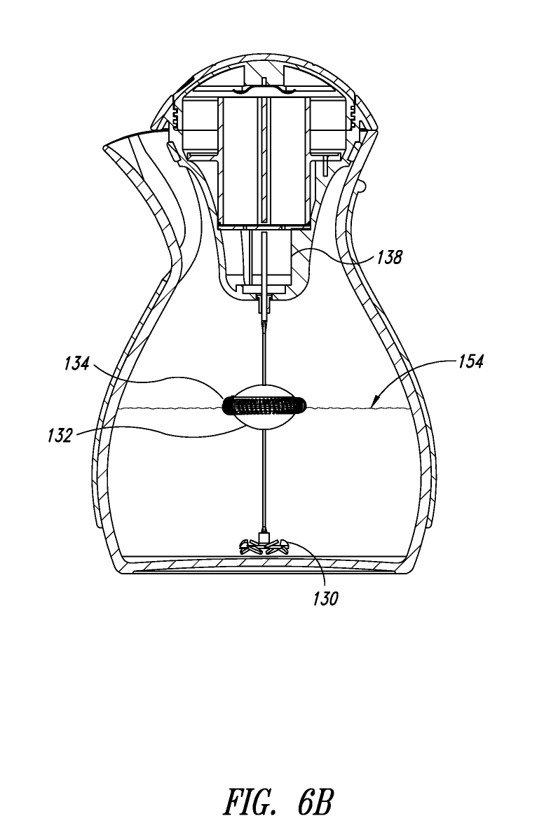

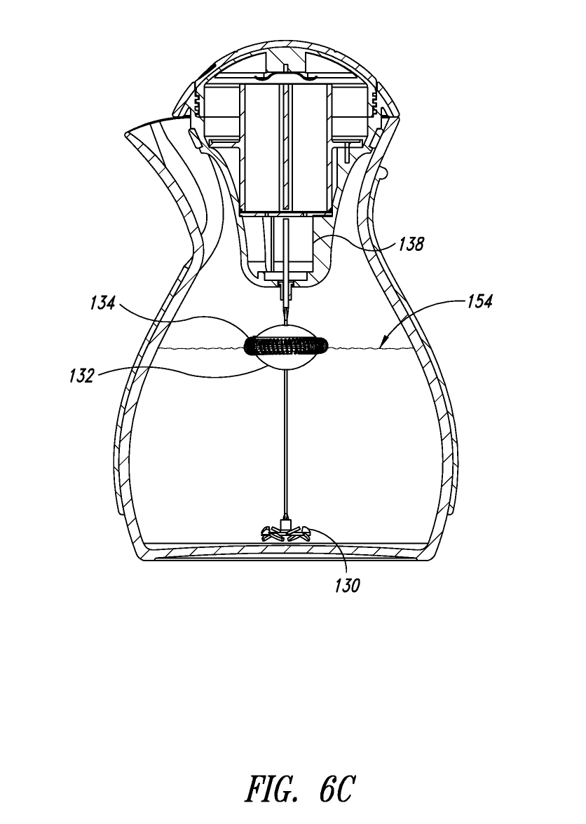

FIGS. 3-6 further illustrate some of the components of the insert 104. In FIG. 3 the housing 120 (and motor 138 therein) has been removed to allow viewing of the components therein. The shaft 128 engages the motor 138, which is seated in the housing 120, as best illustrated in FIGS. 6A-6C. The motor 138 is electrically coupled to a power source 140, such as the illustrated battery housing. A bushing 142 or other type of seal can prevent liquid from entering the housing 120. The illustrated power source 140 is adapted to hold two batteries; however, an individual of ordinary skill in the art, having reviewed this entire disclosure, will immediately appreciate that other power sources could be used.

The illustrated button 126 is incorporates an outer layer 144 of flexible material that allows users to depress the button 126 and can prevent liquid or other impurities from entering into the cap 122. The flexible material of the outer layer 144 deforms when the button 126 is pushed, and return to its original shape when the button is released.

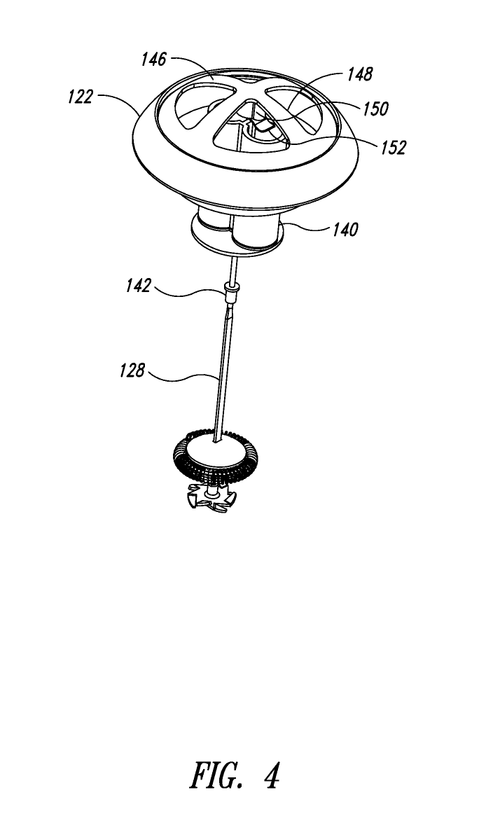

In FIG. 4 the outer layer 144 has been removed to allow for viewing of components inside the cap 122. An inner layer 146 can be positioned beneath the outer layer 144 to move therewith, or in response thereto, during actuation. The illustrated inner layer 146 incorporates radially oriented lengths 148 of a resilient material, which can connect in the middle to form intersecting bridges across and above an open area inside the cap and above the power source 140. The lengths 148 of resilient material cause the button 126 to spring back to its natural state when pressure is released.

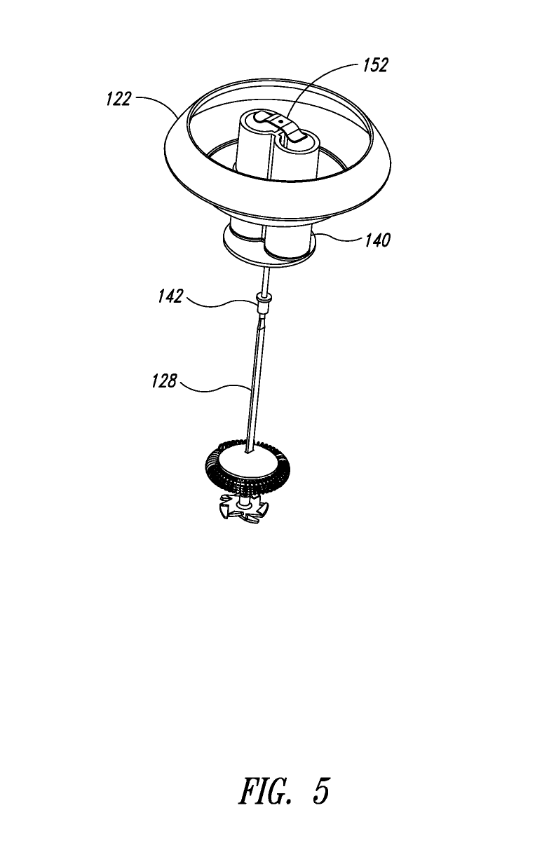

A projection 150 on a bottom surface of the inner layer 146, located at a point of intersection of the lengths 148, is oriented downward. When the button 126 is depressed, the outer layer 144 and inner layer 146 deflect downward, causing the projection 150 to move downward. As the projection 150 moves downward, it causes a contact 152 to close a circuit including the power source 140 (batteries not shown) and the motor 138, driving the shaft 128. The contact 152 can best be seen in FIG. 5, in which the inner layer 146 has been removed. As indicated above, when pressure is released from the button 126, the resilient lengths 148 return the button returns to its natural state and the projection 150 moves away from the contact 152, breaking the circuit and stopping the device 100. An individual of ordinary skill in the art, having reviewed this entire disclosure, will immediately appreciate that different switch designs can be incorporated into the insert 104 without deviating from the spirit of the invention.

FIGS. 6A through 6C illustrate the device 100 in different conditions. In FIG. 6A, the pitcher 106 contains a small volume of a liquid 154; in FIG. 6B, the pitcher contains more liquid than in FIG. 6A; and in FIG. 6C, the pitcher contains a high volume of liquid. As can be readily appreciated by comparing the three figures, as the liquid 154 level in the pitcher 106 rises, the float 132 remains at or near an upper surface of the liquid. The frother 134 is fixed with respect to the float 132 and, as such, also remains at or near the surface of the liquid 154. The mixer 130, however, can remain in a fixed location. As a result, the mixer 130 stirs and mixes the liquid 154, while the frother 134 foams the top portion of the liquid, regardless of the liquid level in the pitcher 106. An individual of ordinary skill in the art, having reviewed this disclosure in its entirety, will immediately appreciate that the size, shape and other features of the float 132 and frother 134 can be modified to cause the frother to rest just at, above or below the upper surface of the liquid, as desired for frothing purposes. Other modifications can be made to the design without deviating from the spirit of the invention.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A device for simultaneously mixing and frothing a liquid, the device comprising:
a container adapated to hold a volume of the liquid, the container having a bottom, a sidewall, and at least one opening;
an insert removably received by the container during operation, the insert having an upper portion and a lower portion, the upper portion of the insert projecting outwards from the container during operation, the lower portion of the insert comprising a shaft having a distal end located near the bottom of the container during operation;
a motor operable to rotate the shaft during operation;
a mixing blade fixedly coupled with respect to the distal end of the shaft; and
a frothing assembly movably coupled to the shaft, the frothing assembly comprising a float and a frother, the float adapted to maintain the float and frother near an upper surface of the liquid during use such that, regardless of the liquid level in the container, the frother is position near the top surface to selectively froth the liquid therein.

2. The device of claim 1, further comprising a power source and switch for selectively powering the motor to drive the shaft.

3. The device of claim 1, further comprising a power source and switch for selectively powering the motor to drive the shaft, the power source and the switch being located in the insert.

4. The device of claim 1 wherein the container is a pitcher.

5. The device of claim 1 wherein the container is a pitcher and the insert is adapted to be received by an opening in the top of the pitcher.

6. The device of claim 1 wherein the insert also comprises a cap, the cap holding the motor and a power source and further comprising a switch to control the motor.

7. The device of claim 1 wherein the float is slidably coupled to the shaft.

8. A device for simultaneously mixing and frothing a liquid, the device comprising:
a container adapated to hold a volume of the liquid, the container having a bottom, a sidewall, and at least one opening;
an insert removably received by the container during operation, the insert comprising a shaft having a distal end located near the bottom of the container during use;
a cap, the cap at least substantially covering the opening during use;
a motor coupled to the shaft and being operable to rotate the shaft;
a power source and a switch operable to selectively power the motor;
a mixing blade fixedly coupled with respect to the distal end of the shaft; and
a frothing assembly movably coupled to the shaft, the frothing assembly comprising a float and a frother, the float adapted to maintain the float and frother near an upper surface of the liquid during use such that, regardless of the liquid level in the container, the frother is position near the top surface to selectively froth the liquid therein.

9. The device of claim 8 wherein the cap is coupled to the insert.

10. The device of claim 8 wherein the motor is inside the insert.

11. The device of claim 8 wherein the power source is inside the insert.

12. The device of claim 8 wherein the switch is inside the insert.
